(19) United States
(12) Patent Application Publication
(10) Pub. No.: US 2002/0134971 A1
(43) Pub. Date: Sep. 26, 2002

(54) Wrecking tool

(76) Inventor: Keith Christensen, South Weber, UT (US)

Correspondence Address: Att: John C. Stringham, WORKMAN NYDEGGER & SELLEY, 1000 EAGLE GATE TOWER, 60 EAST SOUTH TEMPLE, SALT LAKE CITY, UT, 84111, US

(21) Appl. No.: 10/100,844

(22) Filed: Mar. 19, 2002

Related U.S. Application Data
(60) Provisional application No. 60/277,493, filed on Mar. 21, 2001.

(51) Int. Cl. B66F 15/00

(52) U.S. Cl. 254/25

(57) ABSTRACT

A wrecking tool is provided that includes a handle having an attached demolition head which can be oriented in various ways to perform work, such as by imposition of a moment and/or a force, on one or more selected structural elements in response to a force applied to the handle. The demolition head is rotatably attached to the handle so that the position of the demolition head with respect to the handle may be adjusted as desired, and the demolition head includes two tines having a wedge shaped configuration and disposed in a spaced apart arrangement with respect to each other.

### CROSS-REFERENCE TO RELATED APPLICATIONS

This application hereby claims priority to U.S. Provisional Patent Application Serial No. 60/277,493 entitled WRECKING BAR, filed Mar. 21, 2001, and incorporated herein in its entirety by this reference.

### BACKGROUND OF THE INVENTION

1. Technological Field

The present invention relates generally to hand tools. More particularly, embodiments of the present invention relate to a wrecking tool that includes a handle having an attached demolition head which can be oriented in various ways to perform work, such as by imposition of a moment and/or a force, on a selected structural element in response to a force applied to the handle.

2. Related Technology

The quick, safe, and effective disassembly of various types of structures is a matter of particular interest to those engaged in the demolition and/or construction industries. Demolition efforts are typically driven by a variety of considerations. For example, the ability to quickly and effectively demolish a building or structure is desirable because it permits the contractor or builder to execute the associated project more rapidly, and thus may enhance the ability of the contractor to take on relatively more work in a given time frame than would otherwise be possible. Such an increase in workload often translates to increased revenues for the contractor.

A related consideration concerns the materials which make up the structure to be demolished. In particular, it may be desirable in some cases to preserve, to the extent practicable, materials removed from the demolished structure. By reusing such materials, a contractor may realize significant savings in terms of the cost associated with a particular project. In such cases, operators performing the demolition must be sensitive to the need to minimize the damage incurred by the materials that make up the structure to be demolished.

With these and other considerations in mind, various tools have been developed for use in demolition and disassembly processes. Examples of such tools include sledgehammers, crowbars, and various types of pry bars. As discussed in greater detail below, however, such tools have proven inadequate in many cases.

By way of example, sledgehammers are often used in a variety of demolition projects. However, sledgehammers are necessarily heavy and it is often difficult for an individual to use a sledgehammer effectively for an entire work shift. Moreover, the use of sledgehammers in demolition projects often causes heavy damage to the materials comprising the structure being demolished. This is due in part to the fact that tools such as sledgehammers are neither configured nor intended for careful and precise demolition work. Thus, it is oftentimes the case that little or none of the material from a structure demolished with a sledgehammer can be reused. Because the contractor is unable to reuse such materials, the cost associated with such projects may be relatively higher than would otherwise be the case.

Additionally, the effectiveness of a sledgehammer depends in large part upon the ability of the operator to freely swing the sledgehammer so as to maximize the momentum, and thus the energy, built up by the head of the sledgehammer. Accordingly, sledgehammers are generally ill-suited for use in close quarters where the operator has a limited ability to swing the sledgehammer.

Like sledgehammers, crowbars and pry bars have often proven to be of limited effectiveness. By way of example, a crowbar relies in large part for its utility upon the ability of the operator to drive the wedge-shaped end of the crowbar between the two members to be separated. Because the surface area of this wedge-shaped end is relatively small, the ability of the operator to bring suitable forces to bear on the members to be separated is significantly limited. Moreover, because the forces that are brought to bear are concentrated in a relatively small area, that is, over the surface of the wedge-shaped end, exertion of such forces gives rise to undesirable stress concentrations which can lead to cracking, breakage or other damage to the materials intended to be separated.

Another consideration with respect to the use of crowbars, pry bars, and similar tools is that their reliance on a wedging action is vulnerable in situations where two structural elements are nailed or glued tightly together. By way of example, a stud whose end is nailed and/or glued to another stud or joist presents a difficult situation for a user of a crowbar because the wedge end of the crowbar must be driven into at the point of intersection of the two studs in order to bring such force to bear as is necessary to separate the two structural elements. The presence of glue and/or nails significantly hinders this process. Moreover, efforts to insert the crowbar or pry bar in this way are time consuming, require significant effort, and may well result in serious damage to one or both of the members to be separated. Consequently, members separated in this way are often unsuited for reuse.

Moreover, other shortcomings associated with crowbars and pry bars relates to their ability to impose primarily lifting forces, or forces generally oriented in a substantially vertical direction, such as are exerted, for example, when attempting to remove a vertical stud from a stud wall. Such lifting forces are often ineffective when the structural element, such as a stud in a stud wall, to be lifted away is joined at its top and bottom ends to other structural elements.

While the discussion has thus far focused on the demolition processes performed by personnel such as contractors, it should be noted that those in various other occupations likewise have a need for safe and effective demolition tools. By way of example, firefighters and rescue personnel are often required to quickly access buildings and other structures in what are often potentially life-threatening conditions. One complicating factor is that such personnel often encounter situations where the building that is desired to be accessed is locked or otherwise secured. Because of shortcomings in their geometry and effectiveness, examples of which are discussed above, traditional tools such as crowbars and various pry bars may not be effective in all cases. This issue is of particular concern where the preservation of lives and property may hinge on the ability of such firefighters and rescue personnel to quickly access burning buildings, for example.

Accordingly, what is needed is a wrecking tool having features directed to addressing the foregoing exemplary considerations, and others. An exemplary wrecking tool should be constructed to be operated in a way that effectively separates joined structural elements while minimizing damage to the separated structural elements and to the surrounding structure. Furthermore, the wrecking tool should be constructed so that it may be readily and effectively employed even in relatively constricted spaces, and for relatively long periods of time. Finally, the wrecking tool should be constructed so that it is capable of being employed in a variety of different orientations and configurations such that work can be efficiently and effectively performed on one or more structural elements in a variety of different ways.

### BRIEF SUMMARY OF AN EXEMPLARY EMBODIMENT OF THE INVENTION

In general, embodiments of the invention are concerned with a wrecking tool that is useful in effecting demolition or disassembly of various types of structures.

In one exemplary embodiment of the invention, a wrecking tool is provided that includes a handle having an attached demolition head which can be oriented in various ways to perform work, such as by imposition of a moment and/or a force, on one or more structural elements in response to a force applied to the handle. In this exemplary embodiment, the demolition head includes two tines configured in a spaced apart arrangement and positioned in a predetermined orientation with respect to the handle. Each of the tines is configured substantially in the shape of a wedge.

In an exemplary application of the wrecking tool, an operator desiring to separate first and second structural elements from each other orients and positions the demolition head in a manner suited to the particular demolition situation. The operator may then, by applying a force of suitable magnitude, orientation, and point of application, to the handle, cause a moment and/or a force, for example, to be imposed on one or both of the structural elements so as to effect their separation.

These and other features and advantages of the present invention will become more fully apparent from the following description and appended claims.

### BRIEF DESCRIPTION OF THE DRAWINGS

In order that the manner in which the above-recited and other advantages and features of the invention are obtained, a more particular description of the invention briefly described above will be rendered by reference to specific embodiments thereof which are illustrated in the appended drawings. Understanding that these drawings depict only exemplary embodiments of the invention and are not therefore to be considered limiting of its scope, the invention will be described and explained with additional specificity and detail through the use of the accompanying drawings in which:

FIG. 1 is a perspective view that illustrates various features of an exemplary embodiment of a wrecking tool;

FIG. 2 is a side view of the exemplary embodiment illustrated in FIG. 1, and illustrates an angle δ cooperatively defined by the tines of the demolition head and the handle;

FIG. 3 is a combination perspective view and force diagram that illustrates aspects of an exemplary application wherein work is performed on one or more structural elements by an embodiment of a wrecking tool;

FIG. 4 is a combination perspective view and force diagram that illustrates aspects of another exemplary application where work is performed on one or more structural elements by an embodiment of a wrecking tool;

FIG. 5 is a top view illustrating aspects of yet another exemplary application of an embodiment of an embodiment of a wrecking tool wherein the illustrated embodiment of the wrecking tool is employed to remove an overlayment from a supporting structure;

FIG. 6 is a side view illustrating various aspects of an exemplary embodiment of a wrecking tool that includes a removable demolition head having tines whose position is adjustable relative to the handle;

FIG. 7 is a perspective view of an exemplary embodiment of a removable demolition head that includes two tines each of which is configured substantially in the shape of a wedge;

FIG. 8 is a perspective view of another exemplary embodiment of a removable demolition head that includes two relatively short tines;

FIG. 9 is a perspective view of another exemplary embodiment of a removable demolition head that includes two tines with upward tilting ends;

FIG. 10 is a perspective view of yet another exemplary embodiment of a removable demolition head that includes two short tines with upward curving ends; and

FIG. 11 is a perspective view of an exemplary embodiment of a wrecking tool including various features such as a wrench portion and selected sharpened edges.

### DETAILED DESCRIPTION OF VARIOUS EMBODIMENTS OF THE INVENTION

Reference will now be made to figures wherein like structures will be provided with like reference designations. It is to be understood that the figures are diagrammatic and schematic representations of various embodiments of the invention, and are not to be construed as limiting the present invention, nor are the figures necessarily drawn to scale.

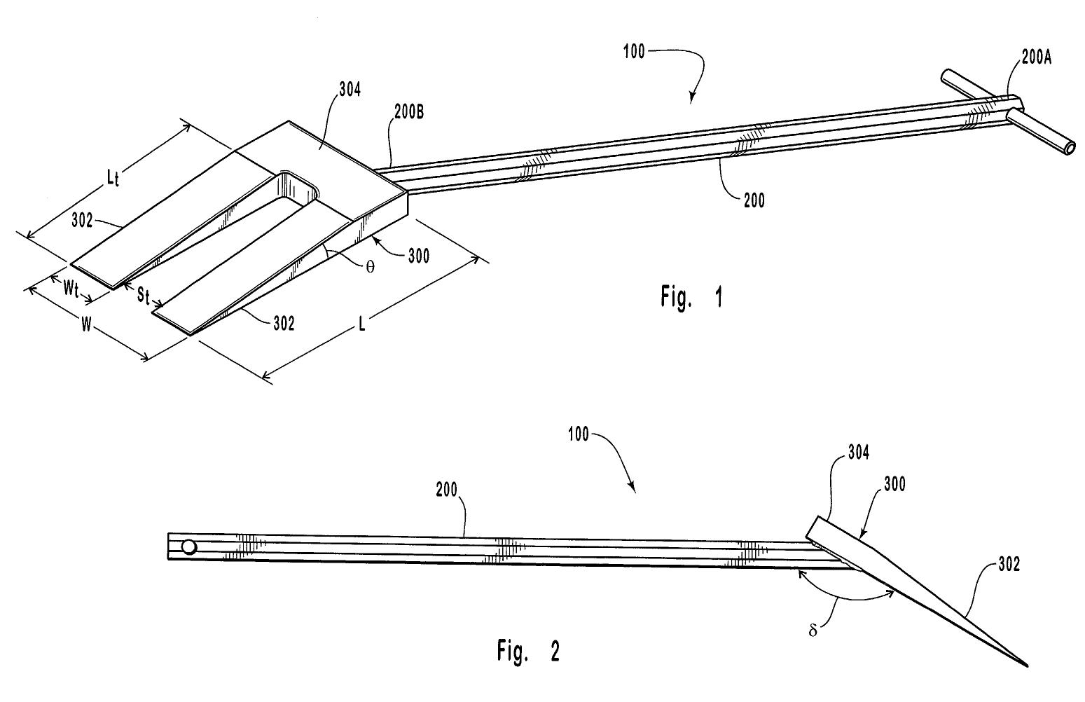

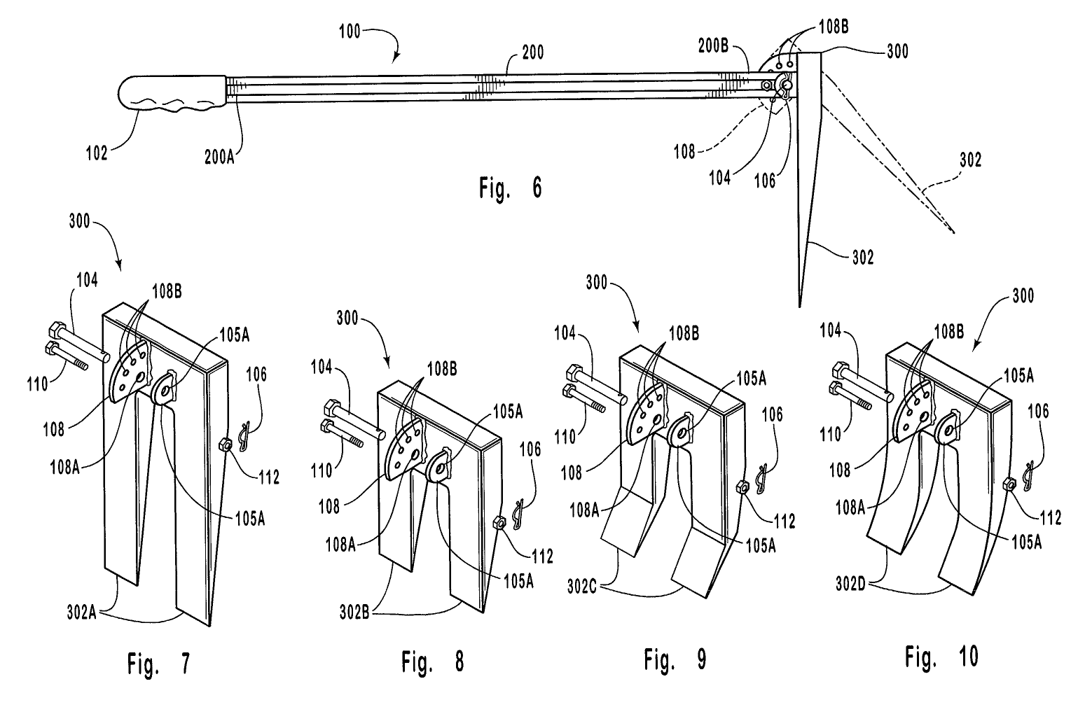

With reference first to FIGS. 1 and 2, an exemplary embodiment of a wrecking tool is indicated generally at 100, and includes a handle 200 having a first end 200A, and a second end 200B to which demolition head 300 is attached. Some embodiments of wrecking tool 100 further include a handgrip 102 (see, e.g., FIG. 6).

In this exemplary embodiment, handle 200 is configured in a “T” shape and comprises bar stock made of steel or similar materials and having an octagonal cross-section. Various other geometries of handle 200 may alternatively be employed however and aspects such as, but not limited to, the length and diameter of handle 200, may varied as desired. Moreover, the materials used to construct handle 200, as well as demolition head 300, may be varied as necessary to suit a particular application.

By way of example, in situations where relatively light demolition work is to be performed, handle 200 need not be comprised of solid bar stock and may instead comprise rigid metal tubing or other suitable materials. Further, materials other than steel may be employed, to the extent consistent with the requirements of a particular application.

In the exemplary embodiment of wrecking tool 100 illustrated in FIGS. 1 and 2, demolition head 300 is welded to handle 200, but may alternatively be brazed, bolted, or attached with another suitable process and/or structure. Moreover, alternative arrangements may be employed. Specifically, various other exemplary embodiments (discussed herein with reference to FIGS. 6-10) comprise a demolition head 300 that is rotatably attached to handle 200 and is configured such that an angle δ (FIG. 2) cooperatively defined by tines 302 of demolition head 300 and handle 200 can be adjusted by a user as necessary for use in a particular application.

With continuing reference to FIGS. 1 and 2, demolition head 300 includes, in addition to two tines 302, a base portion 304 to which tines 302 are attached. However, other arrangements may be employed that include a different number of tines. In the illustrated embodiment, tines 302 are integral with base portion 304. However, tines 302 may alternatively be constructed separately from base 304 and then attached thereto by welding, brazing, or any other suitable process.

Various aspects of the geometry and arrangement of tines 302 may be modified as necessary to suit the requirements of a particular application. For example, tines 302 need not be configured with the relatively sharp terminus illustrated in FIGS. 1 and 2. In at least some alternative embodiments, tines 302 are truncated to provide for a relatively blunter terminus. Moreover, variables such as, but not limited to, tine length L_{T}, tine width W_{T}, tine spacing S_{T}, the overall width W of demolition head 300, the overall length L of demolition head 300, tine angle θ, and/or the angle δ collectively defined by handle 200 and demolition head 300, may be varied individually or collectively as necessary to suit the requirements of a particular application.

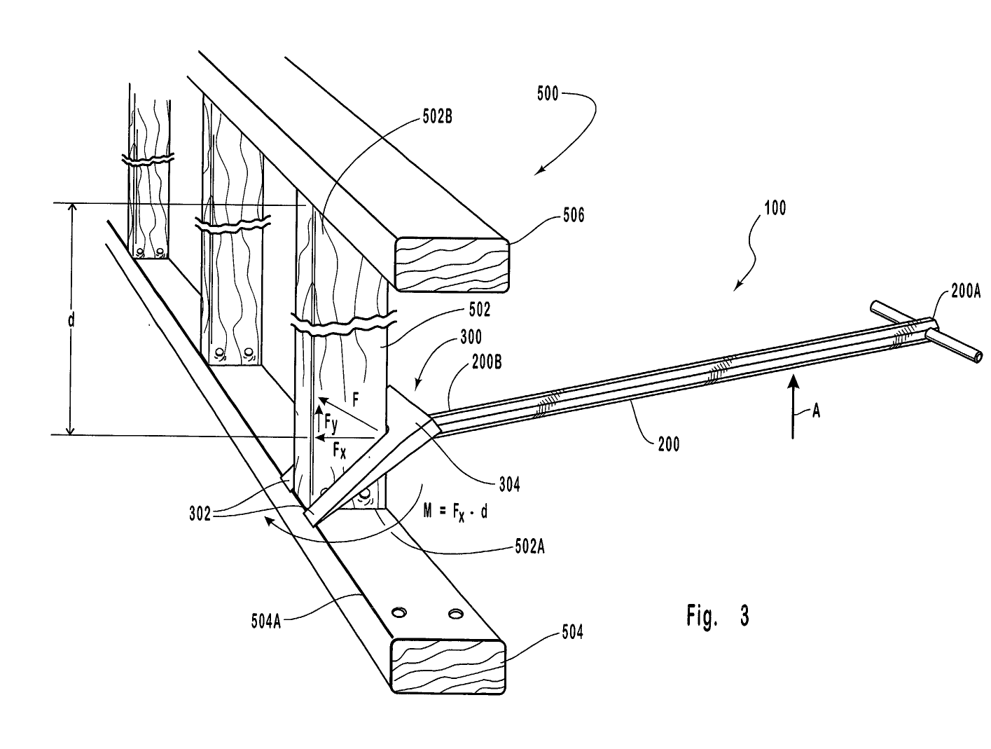

Directing attention now to FIG. 3, various details are provided concerning an exemplary application of wrecking tool 100. In this exemplary application, wrecking tool 100 is employed in conjunction with demolition of a stud wall 500 that includes a substantially vertical stud 502 interposed between, and joined to, floor stud 504 and ceiling stud 506. As indicated in FIG. 3, wrecking tool 100 is positioned such that tines 302 straddle vertical stud 502. As suggested in FIG. 3, the tine length L_{T} (not shown) is such that tines 302 are able to extend some distance past edge 504A of floor stud 504 when wrecking tool 100 is positioned as shown.

Of course, various aspects of the geometry and/or arrangement of tines 302 may be varied as necessary to suit a particular application or situation. With reference to FIG. 3 for example, variables such as, but not limited to, the tine length L_{T} and/or tine spacing S_{T} may be adjusted as necessary to accommodate 2×4s, 2×6s, 2×8s, 4×4s, or various other structural configurations or elements.

More generally however, tines 302 may be configured and/or arranged in any way that facilitates implementation of one or more aspects of the functionality disclosed herein, and the scope of the invention should, accordingly, not be construed to be limited to any particular configuration or arrangement of tines 302.

In operation, work is performed on vertical stud 502 when an operator applies an upward force A to handle 200. In response to application of force A, a force F, which can be resolved into a vertical component F_{Y} and a horizontal component F_{X}, is exerted on vertical stud 502. In this exemplary application of wrecking tool 100, the vertical component F_{Y} of force F has little material effect on the positioning of vertical stud 502, as vertical stud 502 is substantially restrained from vertical motion by virtue of being attached at either end to floor stud 504 and ceiling stud 506, respectively. Note that by reorienting the line of application of force A, such as in a direction substantially parallel to floor stud 504, an operator may impose a torque T (not shown) on vertical stud 502.

With continuing attention to FIG. 3, component F_{X} of force F acts generally along the line indicated and serves to impose a moment M on vertical stud 502 that causes lower end 502A of vertical stud 502 to rotate with respect to upper end 502B of vertical stud 502 that is joined to ceiling stud 506. Specifically, exertion of force F_{X} at a distance d, measured between the line of action of F_{X} and the intersection of vertical stud 502 with ceiling stud 506, results in a moment M which is defined as the product of F_{X} and D, or F_{X}×d.

Thus, in this exemplary application, wrecking tool 100 affords an operator the ability to, among other things, exert a moment M on vertical stud 502 so as to effect the separation of vertical stud 502 from floor stud 504. As is apparent from the definition of moment M, the greater the distance d between the upper joint formed by the intersection of upper end 502B and ceiling stud 506, and the line of action of F_{X}, the greater the magnitude of the moment exerted on vertical stud 502. The ability to exert this moment M is afforded at least in part by the arrangement and the positioning of tines 302 of demolition head 300.

As suggested above, imposition of moment M in this illustrative example is relatively more useful in effecting separation of vertical stud 502 from floor stud 504 than is the imposition of a lifting force, or force generally oriented in a substantially vertical direction, such as vertical component F_{Y} of force F, at least in part because, as it is arranged in FIG. 3, vertical stud 502 is highly resistant to vertical motion. Thus, tools which are generally only capable of applying lifting forces, such as crowbars, would be of limited utility in the exemplary application illustrated in FIG. 3.

With respect to the exemplary application illustrated in FIG. 3, as well as with respect to the other exemplary applications disclosed herein, variables such as, but not limited to, the magnitude, orientation, and point of application of force A, the orientation of demolition head 300 with respect to handle 200, the geometry of demolition head 300 and handle 200, and the placement of demolition head 300 with respect to vertical stud 502 and ceiling stud 504, or other structure, will necessarily affect the magnitude and orientation of force F, as well as the magnitude and orientation of subcomponents F_{Y} and F_{X}. Further, some or all of such variables may be adjusted as desired to suit the requirements of a particular application. Accordingly, the force diagrams illustrated in FIG. 3, and elsewhere herein, are exemplary only and should not be construed as limiting the scope of the invention in any way.

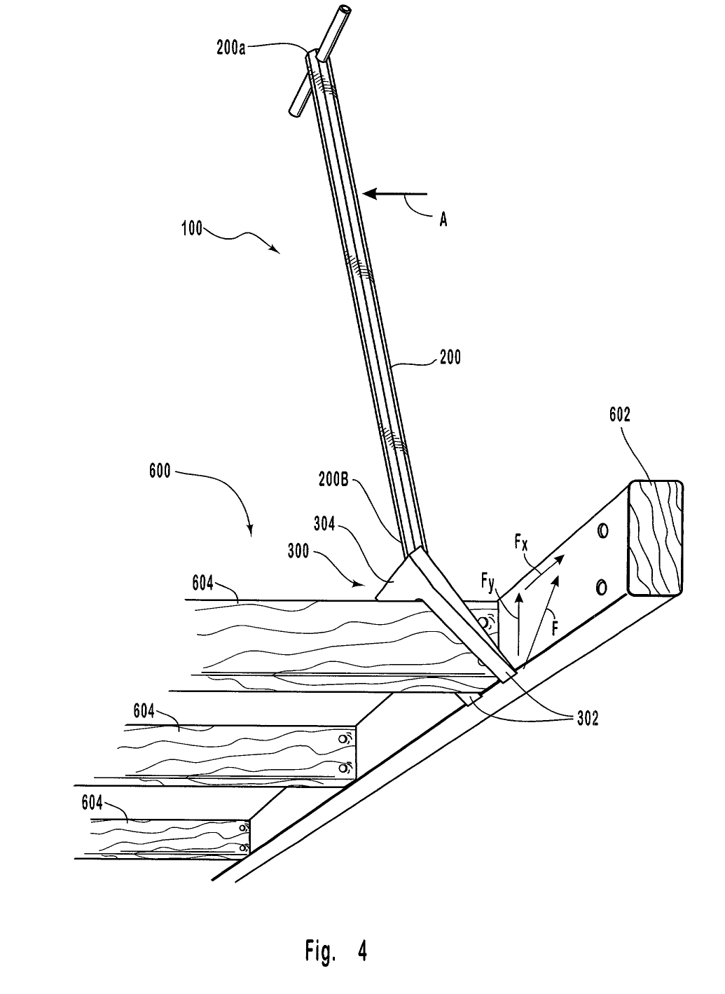

Directing attention now to FIG. 4, various details are provided concerning another exemplary application of an embodiment of wrecking tool 100. In this exemplary application, wrecking tool 100 is employed in conjunction with the demolition of a stud floor 600 that includes an end stud 602 attached to a plurality of stringers 604. As indicated in FIG. 4, wrecking tool 100 is positioned so that tines 302 of wrecking tool 100 straddle one of stringers 604. Further, tines 302 of wrecking tool 100 are positioned so as to extend at least partially beneath end stud 602, as shown.

In operation, exertion of force A on handle 200 of wrecking tool 100 results in the application of a force F to end stud 602. In general, force F can be resolved into a vertical component F_{Y} and a horizontal component F_{X}. In this example, the magnitude of F_{Y} is relatively greater than F_{X} and, accordingly, the work performed on end stud 602 by demolition head 300 primarily comprises imposition of a lifting force F_{Y} which tends to remove F_{Y} from stringer 604 by lifting F_{Y} in a substantially vertical direction. Further, as Suggested in FIG. 4, application of force A to handle 200 of wrecking tool 100 will also result in some horizontal displacement of end stud 602 due to application of force component F_{X}. Note that while, for illustrative purposes, force component F_{X} appears to act in direction parallel to end stud 602, the application of force F will, in fact, cause force component F_{X} in a direction substantially parallel to stringer 604 and substantially perpendicular to end stud 602.

As in the case of other exemplary applications disclosed herein, such as that illustrated in FIG. 3, the work performed on structural elements, such as end stud 602, by way of wrecking tool 100, may desirably be adjusted as necessary to suit the requirements of a particular application. For example, the magnitude, orientation, and line of action of force F as well as the magnitude, orientation, and line of action of its subcomponents F_{Y} and F_{X}, can be readily varied by adjusting the magnitude, orientation, and/or point of application of force A, and/or by modifying various features of the arrangement and geometry of handle 200 and/or demolition head 300.

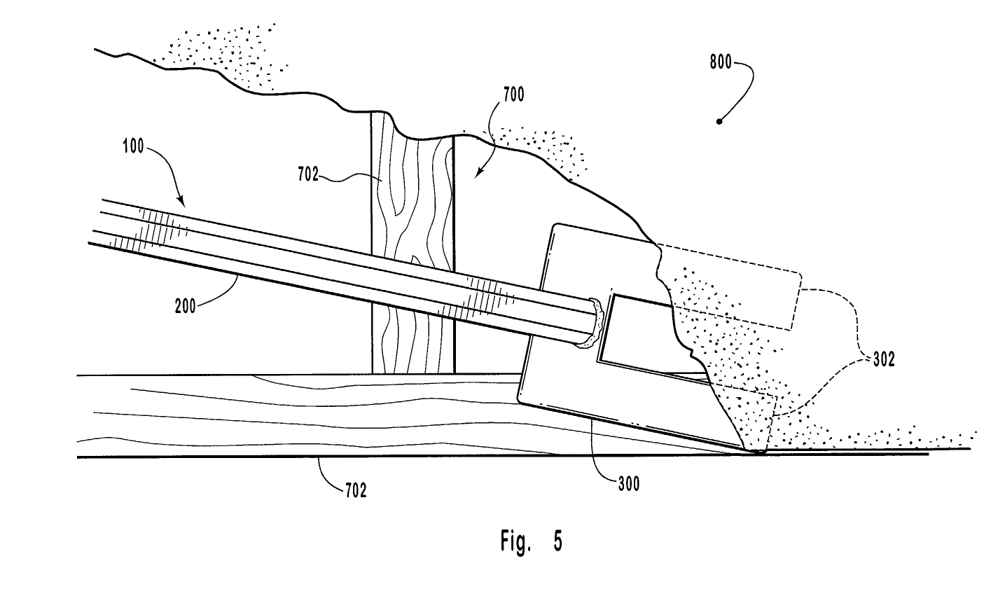

Directing attention now to FIG. 5, various features of yet another exemplary application of an embodiment of wrecking tool 100 are illustrated. In the illustrated application, wrecking tool 100 is employed in conjunction with stripping a stud frame 700 of an overlayment 800 such as plywood, oriented strand board (“OSB”), sheetrock, subfloor, or planking.

In operation, a pushing force applied to demolition head 300 by way of handle 200 causes tines 302 to be forced between overlayment 800 and stud frame 700. By applying a downward force on handle 200, the operator can lift overlayment 800 off studs 702 of stud frame 700. The overlayment 800 removal process is further facilitated by the angle δ cooperatively defined by handle 200 and tines 302 of demolition head 300 (see, e.g., FIG. 2). As in the case of the exemplary application illustrated in FIG. 4, the work performed by demolition head 300 in the application illustrated in FIG. 5 primarily comprises imposition of a lifting force F_{Y} oriented in a substantially vertical direction. Moreover, in the exemplary application illustrated in FIG. 5, at least, application of this lifting force F_{Y} is aided by the lever effect that results from the terminus of tines 302 being located at a position that is relatively higher than base 304 when base 304 resides on a work surface such as stud 702.

As suggested herein, embodiments of wrecking tool 100 are effective in performing work on one or more predetermined structural elements through a variety of different vehicles. As an example, the work performed by way of wrecking tool 100 in the exemplary application illustrated in FIG. 3 primarily comprises imposition of a moment M. This result is desirable in light of the structural configuration illustrated there. As another example, the work performed by way of wrecking tool 100 in the exemplary applications illustrated in FIGS. 4 and 5, respectively, primarily comprises imposition of a force, a lifting force F_{Y} in the case of FIGS. 5 and 5, rather than imposition of a moment M. Again, such a result is desirable in view of the illustrated structural configuration.

Generally then, the work performed by, and results achieved with, wrecking tool 100 may be readily modified in response to the dictates of a particular situation. By adjusting various aspects of the geometry of demolition head 300 and handle 200, as well as their arrangement with respect to each other, and/or by adjusting the positioning of wrecking tool 100 in a particular demolition situation, a wide variety of forces, moments, torques, or combinations thereof, may be exerted by way of wrecking tool 100 in a variety of different situations.

Accordingly, the moments, torques, and forces applied in the exemplary applications of wrecking tool 100 disclosed herein are exemplary only and should be not construed in any way to limit the scope of the invention. Likewise, the applications for, and embodiments of, wrecking tool 100, illustrated and disclosed herein are exemplary only and should not be construed as limiting the scope of the invention in any way. Examples of other yet other applications for embodiments of wrecking tool 100 include removal of deck boards, framing headers, tile, shingles, sidewalk, trusses, siding, masonry facade, carpet tack strips, wood fence and posts, and chain link fence posts.

As suggested by the foregoing, a variety of means may be profitably employed to perform the functions of demolition head 300. Thus, the embodiments of demolition head 300 disclosed herein comprise exemplary structures that serve as a means for performing work on a selected structural element, wherein the work is performed in response to a force applied to handle of the wrecking tool, and wherein performance of such work may comprise imposition of a torque, force, moment, or combination thereof. It should be understood that the structural configurations of demolition head 300 are disclosed herein solely by way of example and should not be construed as limiting the scope of the present invention in any way. Rather, any other structure, feature, or combination of structures, that is effective in implementing the functionality of demolition head 300 disclosed herein may alternatively be employed.

With attention now to FIGS. 6 through 10, details are provided concerning various aspects of an alternative embodiment of wrecking tool 100. As discussed above, it may be advantageous in certain situations to be able to modify the angle δ collectively defined by demolition head 300 and handle 200 (see, e.g., FIG. 2). Accordingly, the embodiments of wrecking tool 100 illustrated in FIGS. 6 through 10 are directed to a wrecking tool 100 configured so that the angle δ can be readily adjusted in response to the requirements of a particular application.

In particular, the illustrated embodiment of wrecking tool 100 includes, in addition to handgrip 102, handle 200 and demolition head 300, a pin 104 that serves to rotatably connect demolition head 300 to handle 200. Pin 104 passes through a retention hole 108A defined by adjustment plate 108 (discussed below) and a retention hole 105A defined by retention plate 105, and is retained in position by cotter pin 106 or other device of similar functionality. Adjustability of the angle δ is afforded in these exemplary embodiments primarily by way of adjustment plate 108 and associated bolt 110.

As indicated in FIGS. 6 through 10, adjustment plate 108 defines a plurality of adjustment holes 108B arranged in a spaced apart configuration with respect to each other, and bolt 110 passes through one of such adjustment holes 108B, through a hole defined in handle 200 (not shown), and is retained in position by nut 112. By removing nut 112 and retracting bolt 110 from adjustment plate 108, an operator may easily adjust the position of demolition head 300 by simply rotating the demolition head about pin 104 until bolt 110 is aligned with an adjustment hole 108B that corresponds to the desired position of demolition head 300. Bolt 110 is then moved into the desired adjustment hole 108B and the hole defined by handle 200, and removably retained in position there by nut 112. Alternatively, the hole defined by handle 200 may be tapped to receive bolt 110, thus obviating the need for nut 112.

Thus, an operator can readily modify the geometry of wrecking tool 100 and, consequently, the nature of the work to be performed, such as imposition of a moment, torque or force, on one or more structural elements. Additionally and/or alternatively, it may be desirable to adjust the geometry of wrecking tool 100 to suit operating conditions, such as but not limited to, the location and orientation of structural elements to be separated, the amount of working space available to the operator, and the like.

Note that in some embodiments, it may be desirable to employ two adjustment plates 108, one disposed on either side of demolition head 300. Further, pin 104, retention plate 105, cotter pin 106, adjustment plate 108, bolt 110, and nut 112 may be comprised of any material suitable to the application in which wrecking tool 100 is to be employed. In at least one embodiment of the invention, the aforementioned components all comprise steel or a steel alloy. Finally, in at least some alternative embodiments of wrecking tool 100 that include a rotatable demolition head 300, first end 200A of handle 200 may be configured with a crowbar, wedge, nail puller, or other type of pry bar configuration so that handle 200 can be used as a wrecking bar when demolition head 300 is not present. In yet other embodiments of wrecking tool 100, second end 200B of handle 200 may be similarly configured.

Note that a variety of means may be profitably employed to perform the functions collectively implemented by pin 104, retention plate 105, cotter pin 106, adjustment plate 108, bolt 110, and nut 112. Accordingly, such elements collectively comprise exemplary structure that serves as a means for adjusting tine position. It should be understood that such structural configurations are presented herein solely by way of example and should not be construed as limiting the scope of the present invention in any way. Rather, any other structure, feature, or combination of structures, that is effective in implementing the functionality disclosed herein may alternatively be employed.

Note in connection with the foregoing, that demolition head 300 may be removably attached to handle 200 through the use of pins, bolts, or similar structures, devices, or fasteners, without necessitating the inclusion of a means for adjusting tine position.

Directing continued attention now to FIGS. 7 through 10, various aspects of alternative embodiments of demolition head 300 are illustrated. The embodiment illustrated in FIG. 7 is generally similar to the embodiment of demolition head discussed elsewhere herein in conjunction with FIG. 6 and, accordingly, need not be considered further. The embodiment of demolition head 300 illustrated in FIG. 8 is similar to that shown in FIG. 7. One difference however, is that tines 302B are relatively shorter than tines 302A illustrated in FIG. 7.

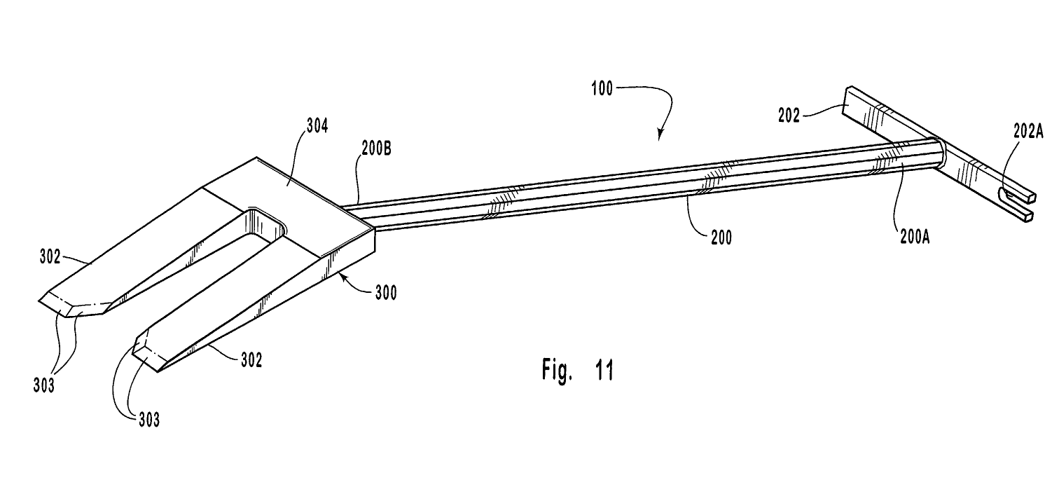

With specific attention now to FIGS. 9 and 10, two alternative embodiments of demolition head 300 are illustrated that include tines 302 configured to point upwardly. In the embodiment illustrated in FIG. 9, tines 302C are in a “bent” configuration, while tines 302D illustrated in FIG. 10 are not bent but simply curve upwardly. The exemplary tine configurations illustrated in FIGS. 9 and 10 provide an additional mechanical advantage to the operator by virtue of their upward pointing configuration. Such arrangements may be particularly useful in situations where, for example, the operator using wrecking tool 100 is working in close quarters.

Directing attention now to FIG. 11, details are provided concerning various aspects of an alternative embodiment of wrecking tool 100. As the illustrated embodiment is similar in at least some regards to other embodiments disclosed herein, the primary focus of the following discussion will be on selected aspects of the illustrated embodiment.

In the illustrated embodiment, each of tines 302 includes at least one sharpened edge 303 formed in a substantially L-shaped configuration. Of course, variables such as, but not limited to, the length, location, and configuration of sharpened edge(s) 303 may be varied as desired to suit the requirements of a particular application. For example, in some embodiments, sharpened edge 303 is located only at the terminus of tine 302. In yet other embodiments, sharpened edge 303 has a substantially U-shaped configuration wherein the terminus of tine 302, as a well as a portion of the inner and outer edges are sharpened. Moreover, different sharpened edge 303 configurations may be combined with variations to the geometry of tines 302, as suggested in FIG. 11 where each tine 302 has a “broken” inner corner and includes a sharpened edge 303.

Embodiments of wrecking tool 100 that include one or more sharpened edges 303 may be usefully employed in a variety of applications. By way of example, one embodiment of wrecking tool 100 includes tines 302 spaced apart from each other such that a deadbolt lock can fit between tines 302. In this exemplary application, sharpened edges 303 permit a firefighter or other personnel to easily position tines 302 in such a way that the deadbolt lock can be quickly and easily pried off of the door. The functionality thus afforded by this exemplary embodiment of wrecking tool 100, that is, the ability of firefighters or other personnel to quickly access a locked building or structure, is particularly useful in cases where time is of the essence and such personnel must act quickly in order to save lives and/or property.

With continuing reference to FIG. 1l, the illustrated embodiment of wrecking tool 100 further includes a wrench portion 202 attached at first end 200A of handle 200 to form a T-shaped configuration. In some embodiments, wrench portion 202 is integral with handle 200. In other embodiments, wrench portion 202 is formed separately from handle 200 and attached thereto by welding, brazing, or similar processes. In yet other embodiments, wrench portion 202 is removably attached to handle 200, such as by pins. Of course, any another other structural arrangement that would facilitate removable attachment of wrench portion 202 to handle 200 may also be employed. Further, wrench portion 202 may be located on handle 200 other than at first end 200A or, alternatively, may be located on demolition head 300 if desired.

In the illustrated embodiment, wrench portion 202 defines a gas cock turn off slot 202A that is located and configured to mate with a gas cock (not shown) so as to permit the use of wrecking tool 100 to secure the flow of gas through the gas cock. Thus, firefighters and rescue personnel, for example, can quickly and easily secure gas flow even if the gas cock is corroded, has deteriorated, or is otherwise resistant to movement. This feature is particularly useful in emergency situations where the unchecked flow of gas, such as natural gas, could cause explosions and fire.

Moreover, wrench portion 202 may be configured to suit any of a variety of uses and applications and, accordingly, the scope of the invention should not be construed to be limited to the exemplary embodiments disclosed herein. By way of example, wrench end 202 may alternatively, or additionally, be configured to mate with fire hydrant valves, water line shutoff valves, or any other device which is desired to be operated, activated, or otherwise acted upon, by way of wrecking tool 100. As another example, wrench portion 202 may be configured to include finger grips or other ergonomic features that facilitate ease of use of wrecking tool 100. Accordingly, the exemplary configurations of wrench portion 202 disclosed herein should not be construed to limit the scope of the present invention in any way.

Moreover, embodiments of wrecking tool 100 should not be construed to be limited solely to the exemplary applications disclosed herein. Rather, wrecking tool 100 may be employed by any personnel in any situation where one or more aspects of the functionality of wrecking tool 100 could be usefully brought to bear.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A wrecking tool, comprising:
(a) a handle; and
(b) a demolition head attached to said handle and positioned at a predetermined angle with respect to said handle, said demolition head including at least two tines disposed in a spaced apart arrangement with respect to each other.

2. The wrecking tool as recited in claim 1, wherein said demolition head is removably attached to said handle.

3. The wrecking tool as recited in claim 1, further comprising means for adjusting tine position.

4. The wrecking tool as recited in claim 3, wherein said means for adjusting tine position permits changes to an angle cooperatively defined by said at least two tines and said handle.

5. The wrecking tool as recited in claim 1, wherein each of said at least two tines is substantially configured in the shape of a wedge.

6. The wrecking tool as recited in claim 1, wherein at least one of said at least two tines includes a sharpened edge.

7. The wrecking tool as recited in claim 1, further comprising wrench portion attached to said handle.

8. A wrecking tool, comprising:
(a) a handle;
(b) a demolition head attached to said handle, said demolition head including at least two tines disposed in a spaced apart arrangement with respect to each other; and
(c) means for adjusting tine position.

9. The wrecking tool as recited in claim 8, wherein said means for adjusting tine position permits changes to an angle cooperatively defined by said at least two tines and said handle.

10. The wrecking tool as recited in claim 8, wherein said means for adjusting tine position permits rotation of said at least two tines with respect to said handle.

11. The wrecking tool as recited in claim 8, wherein said means for adjusting tine position permits said demolition head to be removed from said handle.

12. The wrecking tool as recited in claim 8, wherein each of said at least two tines is substantially configured in the shape of a wedge.

13. The wrecking tool as recited in claim 8, wherein at least one of said at least two tines includes a sharpened edge.

14. The wrecking tool as recited in claim 8, further comprising a wrench portion attached to said handle.

15. The wrecking tool as recited in claim 8, wherein said handle defines a hole and said means for adjusting tine position comprises:
(a) a pin rotatably connecting said demolition head to said handle;
(b) an adjustment plate attached to said demolition head and defining at least one adjustment hole and a retention hole;
(c) a retention plate attached to said demolition head and defining a retention hole substantially aligned with said retention hole defined by said adjustment plate;
(d) a pin configured to be received through said retention holes defined, respectively, by said adjustment plate and said retention plate, and said pin configured to be retained in position by a cotter pin; and
(e) a nut and bolt, said bolt configured to be removably received in said at least one adjustment hole and in said hole defined by said handle, and retained therein by said nut.

16. A wrecking tool suitable for use in performing an operation concerning a structural element, the wrecking tool comprising:
(a) a handle having first and second ends; and
(b) means for performing work on the structural element in response to a force applied to said handle, said work performed on the structural element comprising imposition on the structural element of at least one of: a moment, a force, and a torque.

17. The wrecking tool as recited in claim 16, wherein said force substantially comprises a lifting force.

18. The wrecking tool as recited in claim 16, wherein said work performed on the structural element substantially comprises imposition of a force.

19. The wrecking tool as recited in claim 16, wherein said work performed on the structural element substantially comprises imposition of a moment.

20. The wrecking tool as recited in claim 16, wherein said work performed on the structural element substantially comprises imposition of a torque.

21. The wrecking tool as recited in claim 16, wherein said work performed on the selected structural element comprises imposition of both a moment and a force.

22. The wrecking tool as recited in claim 16, wherein said means for performing work comprises a demolition head attached to said second end of said handle, said demolition head including at least two tines disposed in a spaced apart arrangement with respect to each other.

23. The wrecking tool as recited in claim 22, wherein said at least two tines are positioned at a predetermined angle with respect to said handle.

24. The wrecking tool as recited in claim 22, wherein said demolition head is removably attached to said handle.

25. The wrecking tool as recited in claim 22, wherein each said at least two tines is substantially configured in the shape of a wedge.

26. The wrecking tool as recited in claim 22, further comprising means for adjusting tine position.

27. The wrecking tool as recited in claim 16, further comprising a wrench portion attached to said handle.

28. A wrecking tool, comprising:
(a) a handle comprising bar stock and having first and second ends; and
(b) a demolition head attached to said handle proximate said first end, said demolition head including two integral tines each of which is substantially configured in the shape of a wedge, said two integral tines disposed in a spaced apart arrangement with respect to each other.

29. The wrecking tool as recited in claim 28, wherein at least one of said first end and said second end of said handle is configured in at least one form selected from the group consisting of: crowbars, wedges, and nail pullers.

30. The wrecking tool as recited in claim 28, wherein said demolition head is removably attached to said handle.

31. The wrecking tool as recited in claim 28, wherein at least one of said at least two tines includes a sharpened edge.

32. The wrecking tool as recited in claim 28, further comprising a wrench portion attached to said handle.

33. The wrecking tool as recited in claim 28, further comprising means for adjusting tine position.

34. The wrecking tool as recited in claim 33, wherein said means for adjusting tine position permits changes to be made to an angle cooperatively defined by said at least two tines and said handle.

35. The wrecking tool as recited in claim 33, wherein said handle defines a hole and said means for adjusting tine position comprises:
(a) a pin rotatably connecting said demolition head to said handle;
(b) an adjustment plate attached to said demolition head and defining at least one adjustment hole and a retention hole;
(c) a retention plate attached to said demolition head and defining a retention hole substantially aligned with said retention hole defined by said adjustment plate;
(d) a pin configured to be received through said retention holes defined, respectively, by said adjustment plate and said retention plate, and said pin configured to be retained in position by a cotter pin; and
(e) a nut and bolt, said bolt configured to be removably received in said at least one adjustment hole and in said hole defined by said handle, and retained therein by said nut.

36. A wrecking tool, comprising:
(a) a handle comprising having first and second ends;
(b) a wrench portion attached to said handle proximate said first end; and
(c) a demolition head attached to said handle proximate said second end, said demolition head including two tines disposed in a spaced apart arrangement with respect to each other, at least one of said tines including at least one sharpened edge.

37. The wrecking tool as recited in claim 36, wherein said wrench portion defines a gas cook turn off slot.

38. The wrecking tool as recited in claim 36, further comprising means for adjusting tine position.

39. The wrecking tool as recited in claim 36, wherein said wrench portion cooperates with said handle to form a substantially T-shaped configuration.
